(19) United States
(12) Patent Application Publication
(10) Pub. No.: US 2025/0271185 A1
(43) Pub. Date: Aug. 28, 2025

(54) Thermal Barriers For Compressor Discharge Chambers or Cavities

(71) Applicant: Copeland LP, Sidney, OH (US)

(72) Inventors: Rossdeep KHATRA, Dayton, OH (US); Kevin J. GEHRET, Minster, OH (US)

(21) Appl. No.: 19/038,194

(22) Filed: Jan. 27, 2025

Related U.S. Application Data
(60) Provisional application No. 63/557,131, filed on Feb. 23, 2024.

(51) Int. Cl. F25B 31/02

(52) U.S. Cl. CPC F25B 31/02

(57) ABSTRACT

Exemplary embodiments are disclosed of thermal barriers (e.g., semi-hermetic thermal barrier coatings, thermally-insulative inserts, etc.) for compressor discharge chambers or cavities. Also disclosed are exemplary methods relating to discharge heat management in a compressor by providing a thermal barrier within a compressor discharge chamber or cavity, which thermal barrier is operable for reducing heat transfer from out of the compressor discharge chamber or cavity to another adjacent portion(s) of the compressor.

### CROSS-REFERENCE TO RELATED APPLICATION

This application claims priority to and the benefit of U.S. Provisional Application No. 63/557,131 filed Feb. 23, 2024. The entire disclosure of this provisional patent application is incorporated herein by reference.

### FIELD

The present disclosure relates to thermal barriers for compressor discharge chambers or cavities.

### BACKGROUND

This section provides background information related to the present disclosure which is not necessarily prior art.

Generally, compressors work by taking in low-pressure gas, compressing the gas by reducing its volume, and then delivering the compressed gas at a higher pressure. There are various types of compressors widely used in different applications and in many industries for tasks such as powering pneumatic tools, refrigeration, air conditioning, and gas processing.

For example, a semi-hermetic compressor is a type of compressor used in air conditioning and refrigeration systems. In the context of HVAC (Heating, Ventilation, and Air Conditioning) systems and refrigeration, the primary function of the compressor is to compress and pump refrigerant gas, raising its pressure and temperature. Semi-hermetic refers to a compressor design that has features of both hermetic and open (or external) types. In a hermetic compressor, the motor and compressor are enclosed within the same housing and cannot be opened for maintenance or repairs. In contrast, an open or external compressor allows access for maintenance. A semi-hermetic compressor is somewhat in between in that the semi-hermetic compressor has a sealed housing like a hermetic compressor but can be opened for certain repairs or maintenance tasks.

A semi-hermetic compressor may be a rotary compressor or a reciprocating compressor. A rotary compressor uses a rotating mechanism (rotor) to compress the refrigerant. In the case of a semi-hermetic rotary compressor, this typically involves a rotor with blades or vanes that rotates within a cylinder to compress the refrigerant. Semi-hermetic rotary compressors are often used in medium to large-sized air conditioning and refrigeration systems due to their efficiency, compact design, and relatively quiet operation. The semi-hermetic nature allows for some serviceability, making it easier to repair or replace components compared to fully hermetic compressors.

By comparison, a reciprocating compressor is a type of positive displacement compressor that uses a piston within a cylinder to compress gas or air. A reciprocating compressor operates by reciprocating (moving back and forth) the piston inside the cylinder to compress the gas. During the intake stroke, the piston moves down, creating a vacuum in the cylinder. This vacuum draws in the gas through an intake valve. The piston then moves upward (the compression stroke) to compress the gas within the cylinder. The compression increases the pressure of the gas. After the gas is compressed, the discharge valve opens. And the piston moves down again (the discharge stroke) allowing the compressed gas to exit the cylinder and enter the discharge system. This compression process increases the pressure of the gas, making it suitable for various industrial applications, such as refrigeration, air conditioning, natural gas processing, and other processes that require compressed air or gas.

### DRAWINGS

The drawings described herein are for illustrative purposes only of selected embodiments and not all possible implementations and are not intended to limit the scope of the present disclosure.

FIG. 1 illustrates a compressor that may be provided with a thermal barrier at least partially along an interior surface(s) defining a discharge chamber or cavity of the compressor according to an exemplary embodiment of the present disclosure.

FIG. 2 includes cross-sectional views of the compressor shown in FIG. 1 and illustrating the compressor discharge chamber or cavity coated with a thermal barrier coating according to an exemplary embodiment of the present disclosure.

Corresponding reference numerals may indicate corresponding (though not necessarily identical) features throughout the several views of the drawings.

### DETAILED DESCRIPTION

Example embodiments will now be described more fully with reference to the accompanying drawings.

During compressor operation, heat from a discharge cavity or chamber of a conventional semi-hermetic compressor is transferred to other parts of the compressor system causing heat soak and poor efficiency. For example, heat from the compressor discharge cavity is transferred to the suction paths, which increases temperature going into the compression chamber and creates lower output pressure. This is because cold air is denser and more compressed, which will result in less energy needed to compress. Oil at higher temperatures will lose lubricating abilities, thereby causing early wear on cylinders, bearings, and piston rings.

After recognizing the above, exemplary embodiments were developed and/or are disclosed herein of thermal barriers (e.g., semi-hermetic thermal barrier coatings, thermally-insulative inserts, etc.) for compressor discharge chambers or cavities. Also disclosed are exemplary methods relating to discharge heat management in a compressor by providing a thermal barrier within a compressor discharge chamber or cavity, which thermal barrier is operable for reducing heat transfer from out of the compressor discharge chamber or cavity to another adjacent portion(s) of the compressor.

Advantageously, providing the thermal barrier at least partially along an interior surface(s) defining the compressor discharge chamber or cavity may improve overall efficiency of the compressor by reducing the amount of heat transferred from the compressor discharge chamber to the rest of the compressor. The thermal barrier will also help the suction temperature to stay consistently low (e.g., thermal barrier will prevent or reduce leak soak, etc.), which proves to be more efficient during compression. The thermal barriers disclosed herein may therefore provide a cost-effective way that is not unduly complicated to decrease heat without sacrificing major design changes.

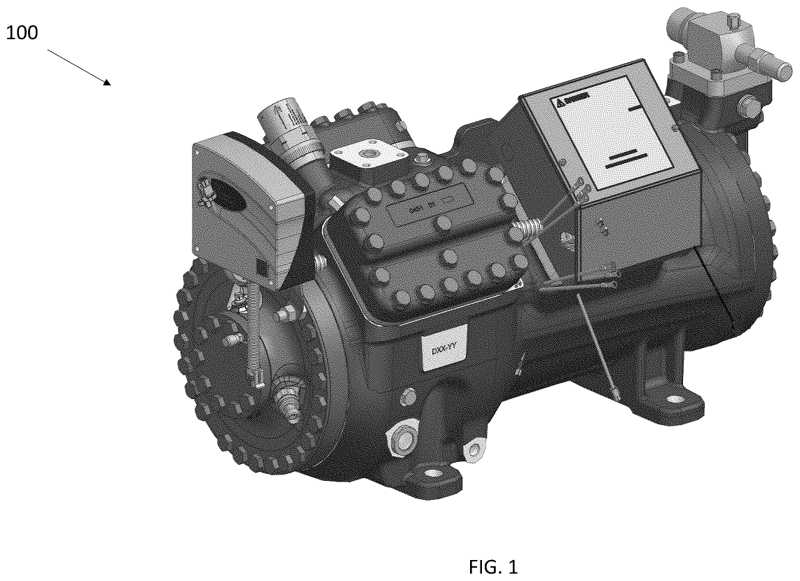

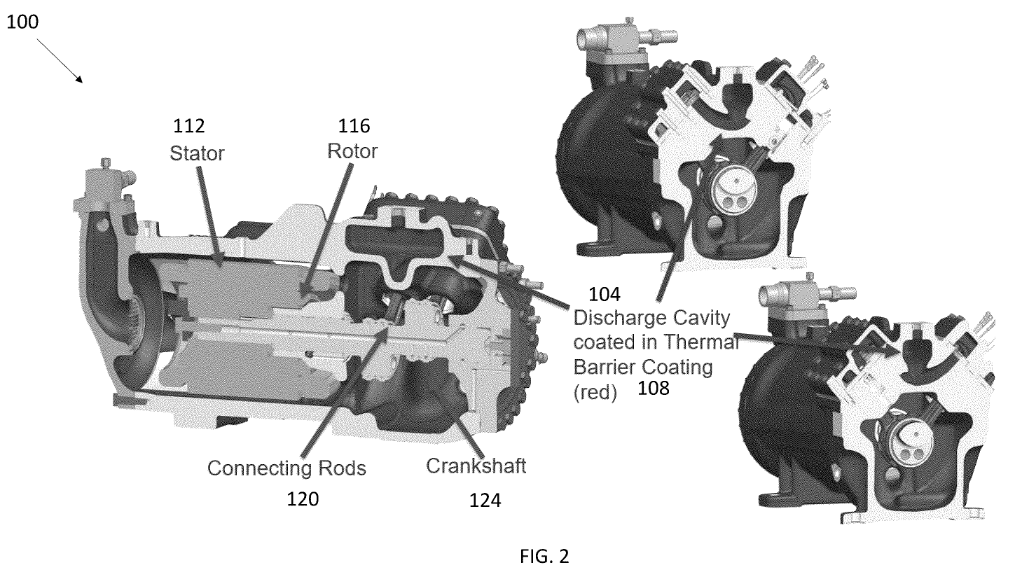

With reference to the figures, FIGS. 1-3 illustrates a compressor 100 including a compressor discharge chamber or cavity 104 coated with a thermal barrier 108 according to an exemplary embodiment of the present disclosure. Also shown in FIG. 2 are a stator 112, rotor 116, connecting rods 120, and crankshaft 124.

In this exemplary embodiment, the thermal barrier 108 comprises a coating that is provided (e.g., coated, sprayed, painted, brushed, deposited, etc.) along the interior surface(s) defining the discharge chamber or cavity 104. The thermal barrier 108 is operable for reducing heat transfer from out of the discharge chamber or cavity 104 to another adjacent portion(s) of the compressor 100.

Alternatively, the discharge chamber or cavity 104 may be provided with a thermal barrier in other ways. For example, other exemplary embodiments include a thermally-insulative insert (e.g., molded plastic insert, etc.) that is molded, positioned, inserted, etc. within the discharge chamber or cavity 104. In such exemplary embodiments, the thermally-insulative insert is operable for reducing heat transfer from out of the discharge chamber or cavity 104 to another adjacent portion(s) of the compressor 100.

In the illustrated embodiment shown in FIG. 2, the compressor 100 comprises the rotor 116 and thus may be referred to as a self-hermetic rotary compressor. But other exemplary embodiments may include a differently configured compressor, e.g., as semi-hermetic reciprocating compressor, a carbon dioxide (CO₂) semi-hermetic compressor, other compressor having a discharge chamber or cavity, etc.

In exemplary embodiments, a thermal barrier is provided either inside the head discharge cavity or inside the discharge cavity that is located in the internal body. In such exemplary embodiments, the thermal barrier may comprises a coating that is provided (e.g., coated, sprayed, painted, brushed, deposited, etc.) inside the head discharge cavity or inside the discharge cavity that is located in the internal body. Alternatively, the thermal barrier may be provided in other ways. For example, a thermally-insulative insert (e.g., molded plastic insert, etc.) may be molded, positioned, inserted, etc. inside the head discharge cavity or inside the discharge cavity that is located in the internal body.

In exemplary embodiments, a compressor comprises a discharge chamber or cavity including a thermal barrier within the discharge chamber or cavity. The thermal barrier is operable for reducing heat transfer from out of the discharge chamber or cavity to another adjacent portion(s) of the compressor.

In exemplary embodiments, the thermal barrier comprises a semi-hermetic thermal barrier coating(s) along at least a portion of an interior surface(s) defining the discharge chamber or cavity.

In exemplary embodiments, the thermal barrier comprises a thermally-insulative coating(s) along at least a portion of an interior surface(s) defining the discharge chamber or cavity.

In exemplary embodiments, the thermal barrier comprises a thermally-insulative material(s) along at least a portion of an interior surface(s) defining the discharge chamber or cavity.

In exemplary embodiments, the thermal barrier comprises a thermally-insulating insert within the discharge chamber or cavity.

In exemplary embodiments, the thermal barrier comprises an insert molded thermally-insulating insert within the discharge chamber or cavity.

In exemplary embodiments, the thermal barrier is along an entirety of the interior surface(s) defining the discharge chamber or cavity.

In exemplary embodiments, the thermal barrier is provided inside a head discharge cavity or inside a discharge cavity located in an internal body of the compressor.

In exemplary embodiments, the thermal barrier is provided inside a head discharge cavity and inside a discharge cavity located in an internal body of the compressor.

In exemplary embodiments, the compressor includes openings, inlet(s) and outlet(s), and/or passageways into and out of the discharge chamber or cavity. And the thermal barrier is within the openings, inlet(s) and outlet(s), and/or passageways into and out of the discharge chamber or cavity.

In exemplary embodiments, the compressor comprises a semi-hermetic compressor, a rotary or reciprocating compressor, and/or a carbon dioxide (CO₂) semi-hermetic compressor.

In exemplary methods relating to discharge heat management in a compressor, the method comprises providing a thermal barrier within a discharge chamber or cavity of the compressor. The thermal barrier is operable for reducing heat transfer from out of the discharge chamber or cavity of the compressor to another adjacent portion(s) of the compressor.

In exemplary methods, providing the thermal barrier within the discharge chamber or cavity comprises coating at least a portion of an interior surface(s) defining the discharge chamber or cavity with a semi-hermetic thermal barrier coating.

In exemplary methods, providing the thermal barrier within the discharge chamber or cavity comprises coating at least a portion of an interior surface(s) defining the discharge chamber or cavity with a thermally-insulative coating(s).

In exemplary methods, providing the thermal barrier within the discharge chamber or cavity comprises providing a thermally-insulative material(s) along at least a portion of an interior surface(s) defining the discharge chamber or cavity.

In exemplary methods, providing the thermal barrier within the discharge chamber or cavity comprises positioning a thermally-insulating insert within the discharge chamber or cavity.

In exemplary methods, providing the thermal barrier within the discharge chamber or cavity comprises insert molding a thermally-insulating insert within the discharge chamber or cavity.

In exemplary methods, providing the thermal barrier within the discharge chamber or cavity comprises providing the thermal barrier along an entirety of the interior surface(s) defining the discharge chamber or cavity.

In exemplary methods, providing the thermal barrier within the discharge chamber or cavity comprises providing the thermal barrier inside a head discharge cavity or inside a discharge cavity located in an internal body of the compressor.

In exemplary methods, providing the thermal barrier within the discharge chamber or cavity comprises providing the thermal barrier inside a head discharge cavity and inside a discharge cavity located in an internal body of the compressor.

In exemplary methods, the compressor includes openings, inlet(s) and outlet(s), and/or passageways into and out of the discharge chamber or cavity. And providing the thermal barrier within the discharge chamber or cavity comprises providing the thermal barrier within the openings, inlet(s) and outlet(s), and/or passageways into and out of the discharge chamber or cavity.

In exemplary methods, the compressor comprises a semi-hermetic compressor, a rotary or reciprocating compressor, and/or a carbon dioxide (CO₂) semi-hermetic compressor.

Aspects of the present disclosure are not limited to any particular type of compressor having a discharge chamber or cavity as exemplary embodiments may be used with various types of compressors, such as semi-hermetic rotary compressors, semi-hermetic reciprocating compressors, other compressors having discharge chambers or cavities, etc. In addition, aspects of the present disclosure are also not limited to compressors for conditioning and refrigeration systems as exemplary embodiments may be used in other industries and applications, such as aviation, automotive, gas processing, powering pneumatic tools, etc.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected, or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, equivalents to the quantities are included.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A compressor comprising a discharge chamber or cavity including a thermal barrier within the discharge chamber or cavity, whereby the thermal barrier is operable for reducing heat transfer from out of the discharge chamber or cavity to another adjacent portion(s) of the compressor.

2. The compressor of claim 1, wherein the thermal barrier comprises a semi-hermetic thermal barrier coating(s) along at least a portion of an interior surface(s) defining the discharge chamber or cavity.

3. The compressor of claim 1, wherein the thermal barrier comprises a thermally-insulative coating(s) along at least a portion of an interior surface(s) defining the discharge chamber or cavity.

4. The compressor of claim 1, wherein the thermal barrier comprises a thermally-insulative material(s) along at least a portion of an interior surface(s) defining the discharge chamber or cavity.

5. The compressor of claim 1, wherein the thermal barrier comprises a thermally-insulating insert within the discharge chamber or cavity.

6. The compressor of claim 1, wherein the thermal barrier comprises an insert molded thermally-insulating insert within the discharge chamber or cavity.

7. The compressor of claim 1, wherein the thermal barrier is along an entirety of the interior surface(s) defining the discharge chamber or cavity.

8. The compressor of claim 1, wherein the thermal barrier is provided inside a head discharge cavity or inside a discharge cavity located in an internal body of the compressor.

9. The compressor of claim 1, wherein the thermal barrier is provided inside a head discharge cavity and inside a discharge cavity located in an internal body of the compressor.

10. The compressor of claim 1, wherein:
the compressor includes openings, inlet(s) and outlet(s), and/or passageways into and out of the discharge chamber or cavity; and
the thermal barrier is within the openings, inlet(s) and outlet(s), and/or passageways into and out of the discharge chamber or cavity.

11. The compressor of claim 1, wherein the compressor comprises:
a semi-hermetic compressor;
a rotary or reciprocating compressor; or
a carbon dioxide (CO₂) semi-hermetic compressor.

12. A method relating to discharge heat management in a compressor, the method comprising providing a thermal barrier within a discharge chamber or cavity of the compressor, whereby the thermal barrier is operable for reducing heat transfer from out of the discharge chamber or cavity of the compressor to another adjacent portion(s) of the compressor.

13. The method of claim 12, wherein providing the thermal barrier within the discharge chamber or cavity comprises coating at least a portion of an interior surface(s) defining the discharge chamber or cavity with a semi-hermetic thermal barrier coating.

14. The method of claim 12, wherein providing the thermal barrier within the discharge chamber or cavity comprises coating at least a portion of an interior surface(s) defining the discharge chamber or cavity with a thermally-insulative coating(s).

15. The method of claim 12, wherein providing the thermal barrier within the discharge chamber or cavity comprises providing a thermally-insulative material(s) along at least a portion of an interior surface(s) defining the discharge chamber or cavity.

16. The method of claim 12, wherein providing the thermal barrier within the discharge chamber or cavity comprises positioning a thermally-insulating insert within the discharge chamber or cavity.

17. The method of claim 12, wherein providing the thermal barrier within the discharge chamber or cavity comprises insert molding a thermally-insulating insert within the discharge chamber or cavity.

18. The method of claim 12, wherein providing the thermal barrier within the discharge chamber or cavity comprises providing the thermal barrier along an entirety of the interior surface(s) defining the discharge chamber or cavity.

19. The method of claim 12, wherein providing the thermal barrier within the discharge chamber or cavity comprises providing the thermal barrier inside a head discharge cavity or inside a discharge cavity located in an internal body of the compressor.

20. The method of claim 12, wherein providing the thermal barrier within the discharge chamber or cavity comprises providing the thermal barrier inside a head discharge cavity and inside a discharge cavity located in an internal body of the compressor.

21. The method of claim 12, wherein:
the compressor includes openings, inlet(s) and outlet(s), and/or passageways into and out of the discharge chamber or cavity; and
providing the thermal barrier within the discharge chamber or cavity comprises providing the thermal barrier within the openings, inlet(s) and outlet(s), and/or passageways into and out of the discharge chamber or cavity.

22. The method of claim 12, wherein the compressor comprises:
a semi-hermetic compressor;
a rotary or reciprocating compressor; or
a carbon dioxide (CO₂) semi-hermetic compressor.
